(19) United States
(12) Patent Application Publication
(10) Pub. No.: US 2009/0033741 A1
(43) Pub. Date: Feb. 5, 2009

(54) 2D-3D CONVERTIBLE DISPLAY DEVICE AND METHOD HAVING A BACKGROUND OF FULL-PARALLAX INTEGRAL IMAGES

(75) Inventors: Yong-Seok Oh, Busan (KR); Suk-Pyo Hong, Seongnam-si (KR); Keong-Jin Lee, Lncheon (KR); Dong-Hak Shin, Busan (KR); Eun-Soo Kim, Seoul (KR)

Correspondence Address: KNOBBE MARTENS OLSON & BEAR LLP, 2040 MAIN STREET, FOURTEENTH FLOOR, IRVINE, CA, 92614, US

(73) Assignees: Eun-Soo Kim, Seoul (KR); KWANGWOON UNIVERSITY RESEARCH INSTITUTE FOR INDUSTRY COOPERATION, Seoul (KR)

(21) Appl. No.: 12/182,876

(22) Filed: Jul. 30, 2008

(30) Foreign Application Priority Data
Jul. 30, 2007 (KR) 10-2007-0076522
Jun. 5, 2008 (KR) 10-2008-0053296

(51) Int. Cl. H04N 13/04

(52) U.S. Cl. 348/51; 348/E13.001

(57) ABSTRACT

A two dimensional to three dimensional (2D-3D) convertible display device is disclosed. In one embodiment, the display device includes i) a first display unit configured to selectively output one of a composite image and backlight, wherein the composite image comprises a background image and a mask image, for an object, wherein the background image comprises element images for a background excluding the object and wherein the mask image is a white image which has the same shape as that of the object, ii) a lens unit configured to convert the composite image into a stereoscopic image or pass through the backlight and iii) a second display unit configured to output i) a two-dimensional (2D) image of the object by the use of the backlight at a 2D mode and ii) the combination of the 2D image and the composite image at a three dimensional (3D) mode.

### CROSS-REFERENCE TO RELATED APPLICATIONS

This application claims the benefit of Korean Patent Application Nos. 10-2007-0076522 and 10-2008-0053296, filed with the Korean Intellectual Property Office on Jul. 30, 2007 and Jun. 5, 2008, respectively, the disclosure of which is incorporated herein by reference in their entirety.

### BACKGROUND

1. Technical Field

The present invention relates to a display device, more particularly to a two dimensional to three dimensional (2D-3D) convertible display device having a background of full-parallax integral images.

2. Description of the Related Technology

With the recent advancement and integration of display technologies, there has been an increasing demand for 3D images as well as a large number of studies on three-dimensional stereoscopic images and display technologies. The 3D display technology may be an ultimate imaging technology, thanks to the ability to show actual image information of an object to an observer.

### SUMMARY OF CERTAIN INVENTIVE ASPECTS

One aspect of the present invention is a composite 3D image display device combining a floating imaging method and an integral imaging method.

Another aspect of the present invention is a display device that displays a primary image of high resolution by using the floating imaging method and displays either a secondary image or a background image by using the integral imaging method.

An aspect of the present invention is a display device which includes: a first display unit, configured to output one of a composite image and backlight; a second display unit, configured to output a main image, a main object having been photographed in the main image; and a lens unit, configured to restore the composite image to a stereoscopic image; wherein the main image is a two-dimensional image, and an integral image constituted by element images excluding the main object and a white image in a same shape and size as the main object are combined in the composite image.

The display device includes a control unit, configured to control the first display unit to output one of the background image and the backlight in accordance with an output mode, the output mode can be one of a two-dimensional mode and a three-dimensional mode. The second display unit can be a transmissive spatial light modulator (SLM). The lens unit can include one of a lens array and a lenslet array (micro lens array).

Another aspect of the present invention is a display method of a display device including a first display unit and a second display unit, the method including: outputting one of a composite image and backlight one of the composite image and the backlight being outputted by the first display unit; outputting a main image, the main image being outputted by the second display unit, a main object having been photographed in the main image; and restoring the composite image to a stereoscopic image; wherein the main image is a two-dimensional image, and an integral image constituted by element images excluding the main object and a white image in a same shape and size as the main object are combined in the composite image.

The step of outputting one of the composite image and the backlight, one of the composite image and the backlight can be outputted in accordance with an output mode, and the output mode can be one of a two-dimensional mode and a three-dimensional mode. The composite image can be an image formed by changing the color of pixels corresponding to the main object into white, the pixels being among pixels of element images corresponding to a background.

Yet another aspect of the present invention is a composite image forming device, which includes: a lens unit, configured to comprise a plurality of tenses; a sensor, configured to form a mask image and a background image by photographing an object by using the lens; and a composition unit, configured to form a composite image by masking a background image with the mask image.

The mask image can be an element image for a main object, the element image being displayed in the form of a binary image. The background image can be an integral image constituted by an element image for a background excluding a main object.

Still another aspect of the present invention is a composite image forming method, which includes: forming a mask image and a background image through a lens array or a lenslet array; and forming a composite image by masking the background image with the mask image.

In the masking, a pixel of the background image corresponding to a white pixel of the mask image can be changed to a white pixel. The mask image can be an integral image constituted by an element image for a main object, the integral image being displayed in the form of a binary image. The background image can be an integral image constituted by an element image for a background excluding a main object.

Still another aspect of the invention is a display device comprising: i) a first display unit configured to selectively output one of a composite image and backlight, wherein the composite image comprises a background image and a mask image, for an object, wherein the background image comprises element images for a background excluding the object, and wherein the mask image is a white image which has the same shape as that of the object, ii) a lens unit configured to convert the composite image into a stereoscopic image or pass through the backlight and ii) a second display unit configured to output i) a two-dimensional (2D) image of the object by the use of the backlight at a 2D mode and ii) the combination of the 2D image and the composite image at a three dimensional (3D) mode.

The above device may further comprise a control unit configured to control the first display unit to selectively output the composite image or backlight based on one of the 2D and 3D modes.

In the above device, the second display unit may be a transmissive spatial light modulator (SLM). In the above device, the lens unit may comprise one of a lens array and a lenslet array (micro lens array).

Still another aspect of the invention is a display method comprising: i) selectively outputting one of a composite image and backlight, wherein the composite image comprises a background image and a mask image, for an object wherein the background image comprises element images for a background excluding the object, and wherein the mask image is a white image which has the same shape as that of the object ii) converting the composite image into a stereoscopic image or passing through the backlight, iii) outputting a two-dimensional (2D) image of the object by the use of the backlight at a 2D mode and iv) outputting the combination of the 2D image and the composite image at a three dimensional (3D) mode.

In the above method, the converting may be performed by one of a lens array and a lenslet array (micro lens array). In the above method, the outputting of the 2D image and the combination image may be performed by a transmissive spatial light modulator (SLM). In the above method, the composite image may be an image formed by changing the color of pixels corresponding to the object into white, and wherein the pixels are part of pixels for element images corresponding to the background.

Still another aspect of the invention is a composite image forming device comprising: i) a lens unit comprising a plurality of lenses, ii) a sensor configured to form a mask image and a background image by photographing an object based on the lens unit and iii) a composition unit configured to combine the mask image and background image so as to form a composite image, wherein the background image comprises element images for a background excluding the object, and wherein the mask image is a white image which has the same shape as that of the object. In the above device, the composite image may be provided to a stereoscopic image display device.

Still another aspect of the invention is a composite image forming method comprising: i) generating a mask image and a background image of an object, wherein the background image comprises element images for a background excluding the object, and wherein the mask image is a white image which has the same shape as that of the object and ii) combining the mask image and background image so as to form a composite image.

In the above method, the generating may comprise changing the color of pixels corresponding to the object into white, and wherein the pixels are part of pixels for element images corresponding to the background. In the above method, the generating may be performed by an image sensor. The above method may further comprise providing the composite image to a stereoscopic image display device.

Still another aspect of the invention is a display device comprising: i) means for selectively outputting one of a composite image and backlight, wherein the composite image comprises a background image and a mask image, for an object, wherein the background image comprises element images for a background excluding the object, and wherein the mask image is a white image which has the same shape as that of the object, ii) means for converting the composite image into a stereoscopic image or passing through the backlight, iii) means for means for outputting a two-dimensional (2D) image of the object by the use of the backlight at a 2D mode and iv) means for outputting the combination of the 2D image and the composite image at a three dimensional (3D) mode.

### BRIEF DESCRIPTION OF THE DRAWINGS

FIG. 1 illustrates a picking up process in an integral imaging method.

FIG. 2 illustrates a real image restoration process of a three-dimensional image.

FIG. 3 illustrates a virtual image restoration process of a three-dimensional image.

FIG. 4 shows how a display device is configured according to an embodiment of the present invention.

FIG. 5 illustrates the structure of a display device according to an embodiment of the present invention.

FIG. 6 shows how a display device operates in a two-dimensional output mode according to an embodiment of the present invention.

FIG. 7 shows how a display device operates to form a real-image background in a three-dimensional output mode according to an embodiment of the present invention.

FIG. 8 shows how a display device operates to form a virtual-image background in a three-dimensional output mode according to an embodiment of the present invention.

FIG. 9 shows how a device forming a composite image is configured according to an embodiment of the present invention.

FIG. 10 shows how a composite element image is formed according to an embodiment of the present invention.

FIG. 11 is a flowchart illustrating a process of displaying a stereoscopic image by using an integral image according to an embodiment of the present invention.

FIG. 12 is a flowchart illustrating a process of forming a composite image according to an embodiment of the present invention.

### DETAILED DESCRIPTION OF CERTAIN INVENTIVE EMBODIMENTS

Display devices can be roughly classified into devices for viewing and devices for business in accordance with their use. The display devices for viewing are used for cinema, animation, TV, game machine and advertisement, to name a few. The devices for business are used for reading and writing a document and e-mail, working on 2D graphics and searching the Internet. The 3D display technology can be effectively applied to the display devices for viewing to address the demand of the users, who desire more realistic display systems. However, the business users are more accustomed to high-resolution 2D display screens. Thus, there has been a need for a display technology that allows the user to switch between a 2D image output mode and a 3D image output mode according to the situation of use, and there also have been a number of studies on 2D-3D convertible display technologies.

One of the typical 2D-3D convertible display technologies is a stereoscopic 2D-3D convertible display method, in which the effect of stereo disparity allows an observer to view a 3D stereoscopic image. The observer, however, often experiences dizziness and strain on the eyes due to the disparity between the two images as well as different focal points between the eyes.

Many of the studies in the display method for providing conversion between 2D and 3D images have employed the integral imaging method in order to solve the above problems of the typical technology. One of the most widely studied 3D display methods recently, the integral imaging method does not require the use of any special auxiliary equipment but allows the users to view 3D images having continuous view points within the range of certain viewing angles and every spectrum of colors. This method, however, is yet to have much improvement in the viewing angle and depth of view.

Additionally, the stereoscopic 2D-3D convertible display method and the integral imaging technology have one common restriction. More particularly, the resolution of a 3D image formed by the display device is inversely proportional to the number of the view points, compared with the resolution of an existing 2D image. Suppose “N” is the number of the view points, for example, and the resolution of the 3D image formed by the multi view method is decreased to 1/N of the resolution of the existing 2D image. Then, the resolution of a 3D integral image formed by an N by N lens array (or an element image) is decreased to 1/(N×N). Thus, the stereoscopic-based 2D-3D convertible display method or the integral imaging technology has a problem of decreased resolution with the increased number of view points.

A new 3D image display method, applying the integral imaging technology to the floating image display technology, has been recently introduced in order to display a high-resolution 3D image. Yet, any floating image formed on one image plane is a 2D image in principle, barring the improvement of three-dimensionality. Besides, the problem of an occlusion region (that is, translucence or overlap, observation of invalid region) between the front and rear images is inevitable in a system simply using two 2D image planes.

Hereinafter, embodiments of the present invention will be described in detail with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description, the detailed description of known technologies incorporated herein will be omitted when it may make the subject matter unclear.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

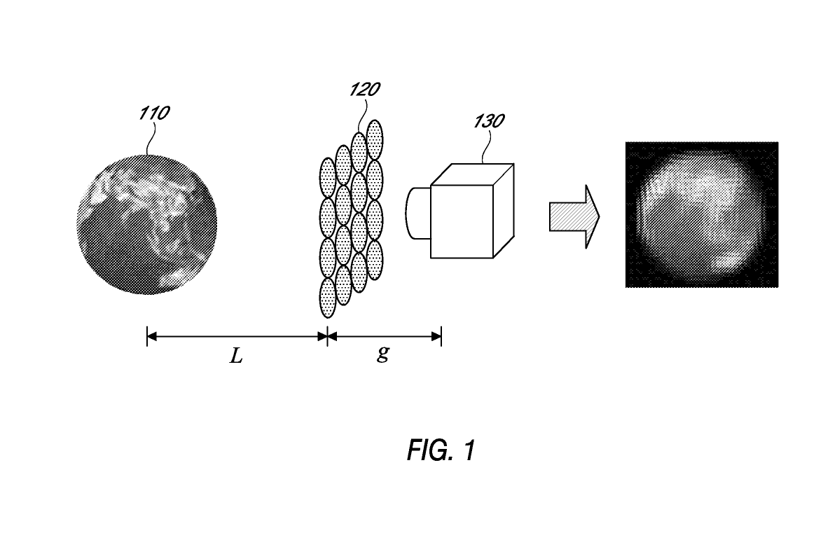

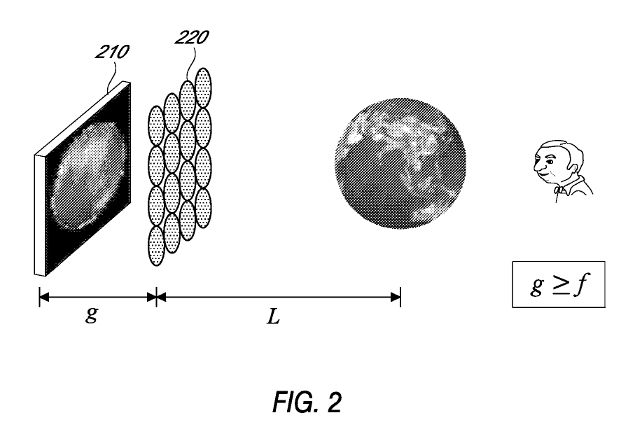

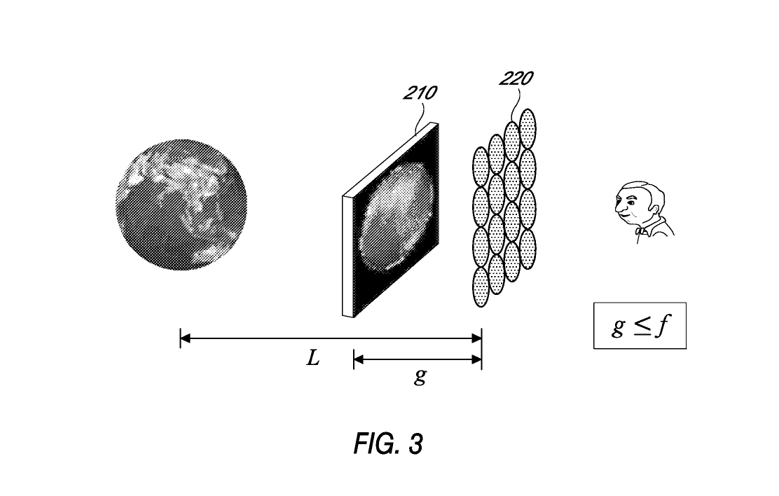

FIG. 1 illustrates a picking up process in an integral imaging method. FIG. 2 illustrates a real image restoration process of a three-dimensional image. FIG. 3 illustrates a virtual image restoration process of a three-dimensional image.

Referring to FIG. 1, light beams emitted from a three dimensional object 110 pass through a lens array 120 and reach an image sensor 130, which can form one element image for each lens of the lens array 120 by sensing the light beams. It is possible that the lens array 120 is a lenslet array (or, a micro lens array, also referred to as MLA).

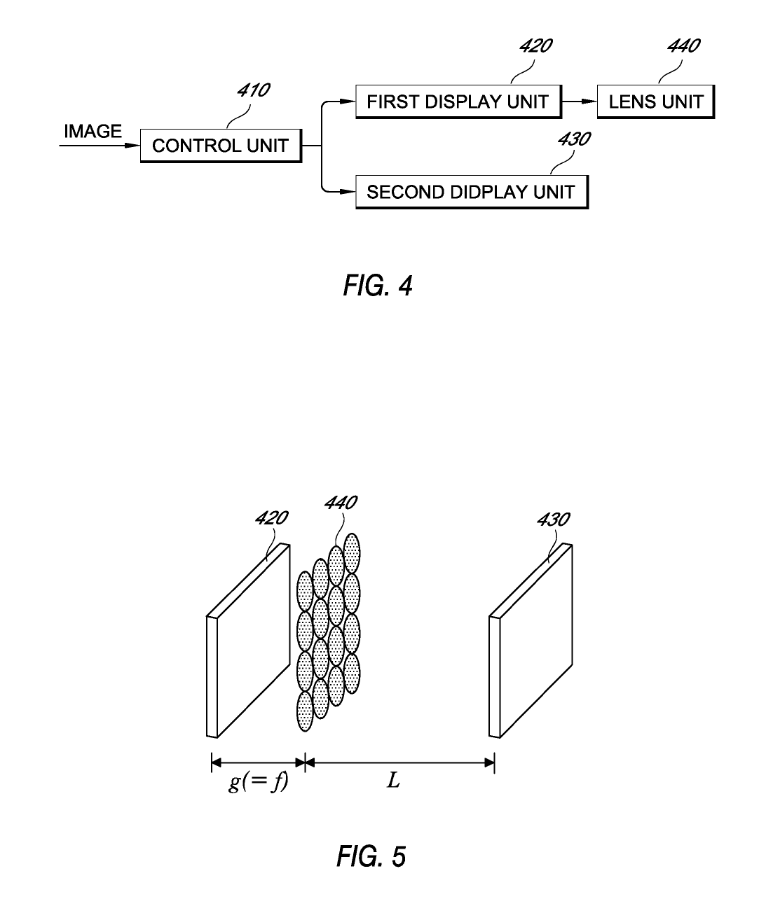

The element images can be restored to three-dimensional images through a restoration process. For example, if it is assumed that the focal length of one lens is “f”, the length between the lens array 120 and a display unit 210 is “g”, and the length between the lens array 220 and an object is “L”, a real image is projected if g≧f as shown in FIG. 2, and a virtual image is observed by an observer if g≦f as shown in FIG. 3, according to a lens formula of 1/L+1/g=1/f. If g=f, several three-dimensional images having different depth effects, including the real image and the virtual image, can be displayed at the same time. Hereinafter, a 2D-3D convertible display device using the element image mentioned above will be described in detail with reference to FIGS. 4 to 8.

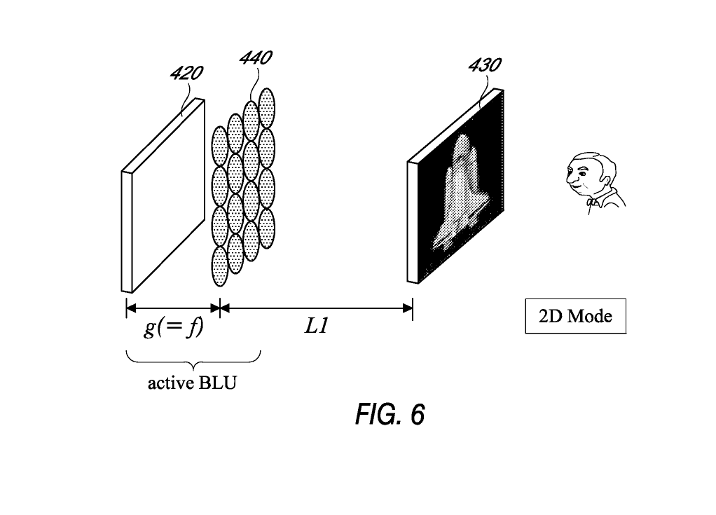

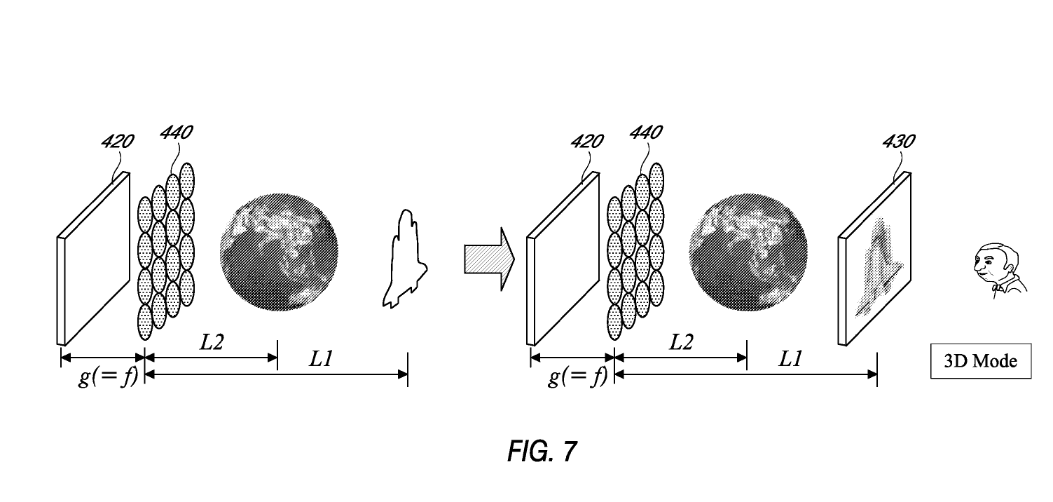

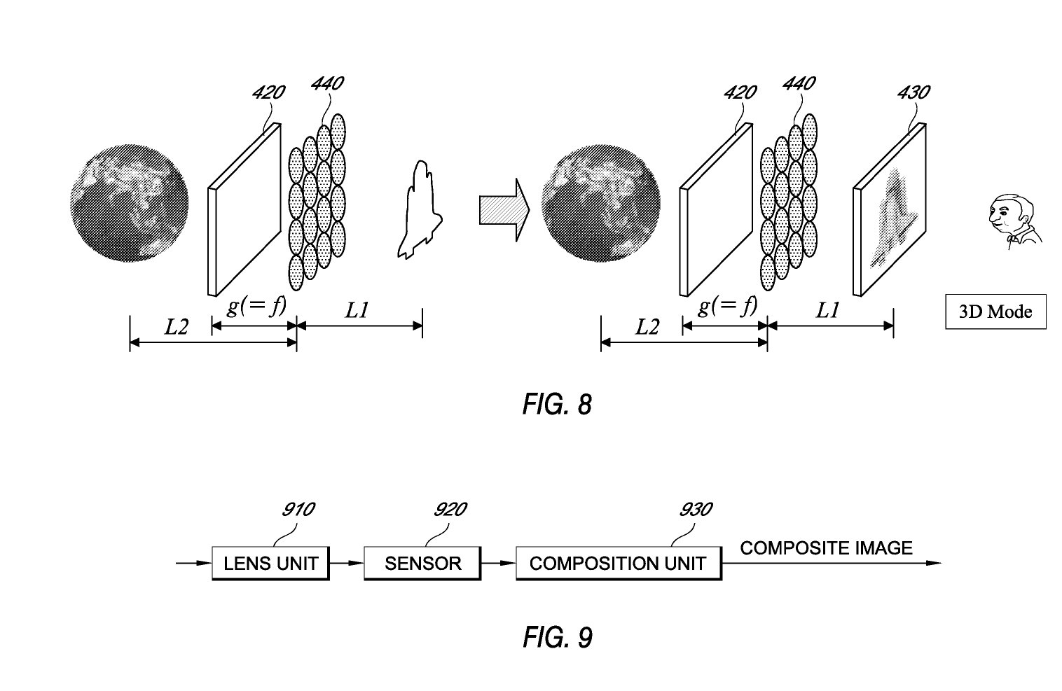

FIG. 4 shows how a display device is configured according to an embodiment of the present invention. FIG. 5 illustrates the structure of a display device according to an embodiment of the present invention. FIG. 6 shows how a display device operates in a two-dimensional output mode according to an embodiment of the present invention. FIG. 7 shows how a display device operates to form a real-image background in a three-dimensional output mode according to an embodiment of the present invention. FIG. 8 shows how a display device operates to form a virtual-image background in a three-dimensional output mode according to an embodiment of the present invention.

Referring to FIG. 4, a display device according to an embodiment of the present invention can include a control unit 410, a first display unit 420, a second display unit 430 and a lens unit 440.

The control unit 410 can control the first display unit 420 and the second display unit 430 such that an image can be displayed according to an output mode (that is, a two-dimensional output mode or a three-dimensional output mode).

For example, in a two-dimensional output mode, the control unit 410 can output two-dimensional image data to the second display unit 430 and control the second display unit 430 to display the data. At the same time the control unit 410 can control the first display unit 420 to function as a light source (backlight) by outputting a backlight signal to the first display unit 420 and turn “on” all the pixels of the first display unit 420.

In a three-dimensional output mode, the control unit 410 controls the first display unit 420 and the second display unit 430 to display a composite image and a main image, respectively. The main image corresponds to a two-dimensional main object image among images to be recognized by an observer. The composite image corresponds to an image made by combining an integral image (hereinafter, referred to as a background image) constituted by element images not including the main object and a white image (hereinafter, referred to as a mask image) having the same shape and size as those of the main object. The composite image will be described later in detail with reference to FIG. 9. Here, an area corresponding to the white image among the composite image mentioned above functions as backlight of the main image.

Then, the control unit 410 can receive a composite image from the outside and control the first display unit 420 to output the composite image. The control unit 410 can combine the white image with the background image and form and output a composite image. The process of forming the composite image will be described below in detail with reference to FIG. 9.

The control unit 410 outputs the main image to the second display unit 430 and controls the second display unit 430 to display the main image. The main image has as high a resolution as that of a general 2D image. As described above, an observer can view a new high resolution composite stereoscopic image of by using the composite image displayed by the first display unit 420 and the main image displayed by the second display unit 430.

The first display unit 420 can display the composite image received from the control unit 410. Moreover, when the first display unit 420 receives a backlight signal, the first display unit 420 can function as a light source (backlight) by turning “on” all of the pixels. The first display unit 420 can be either a two-dimensional display device, such as LCD, PDP and CRT, or a projection-type display device, in which a projector and a screen are combined.

The second display unit 430 can display the main image received from the control unit 410. A transmissive spatial light modulator (SLM), the second display unit 430 can be an LCD panel with a back light unit (BLU) removed. Since the second display unit 430 does not have a backlight function of its own, the first display unit 420 can function as a backlight according to an embodiment of the present invention. Furthermore, the second display unit 430 can display the two-dimensional image received from the control unit 410.

The lens unit 440 can be located between the first display unit 420 and the second display unit 430. The lens unit 440 can restore the integral image projected by the first display unit 420 to a stereoscopic image. The lens unit 440 can be any one of a lens array and a lenslet array (that is, a micro lens array).

As illustrated in FIG. 5, the first display unit 420 and the second display unit 430 mentioned above are successively disposed in a line. The lens unit 440 can be located between the first display unit 420 and the second display unit 430. Accordingly, in a three-dimensional output mode, an observer can recognize the background image, which is displayed through the first display unit 420 and the lens unit 440, through the second display unit 430, which is a transmissive display device. The observer can also enjoy a three-dimensional effect by recognizing the main image displayed by the second display unit 430 along with the background image.

As illustrated in FIG. 6, in a two-dimensional output mode, the observer can recognize a two-dimensional image displayed by the second display unit 430 by using the backlight outputted by the first display unit 420.

Through the first display unit 420 and the lens unit 440, the background image can be formed on either a real image plane, as illustrated in FIG. 7, or a virtual image plane, as illustrated in FIG. 8. When the background image is formed on the virtual image plane, the three-dimensional effect of the overall three-dimensional image can be improved.

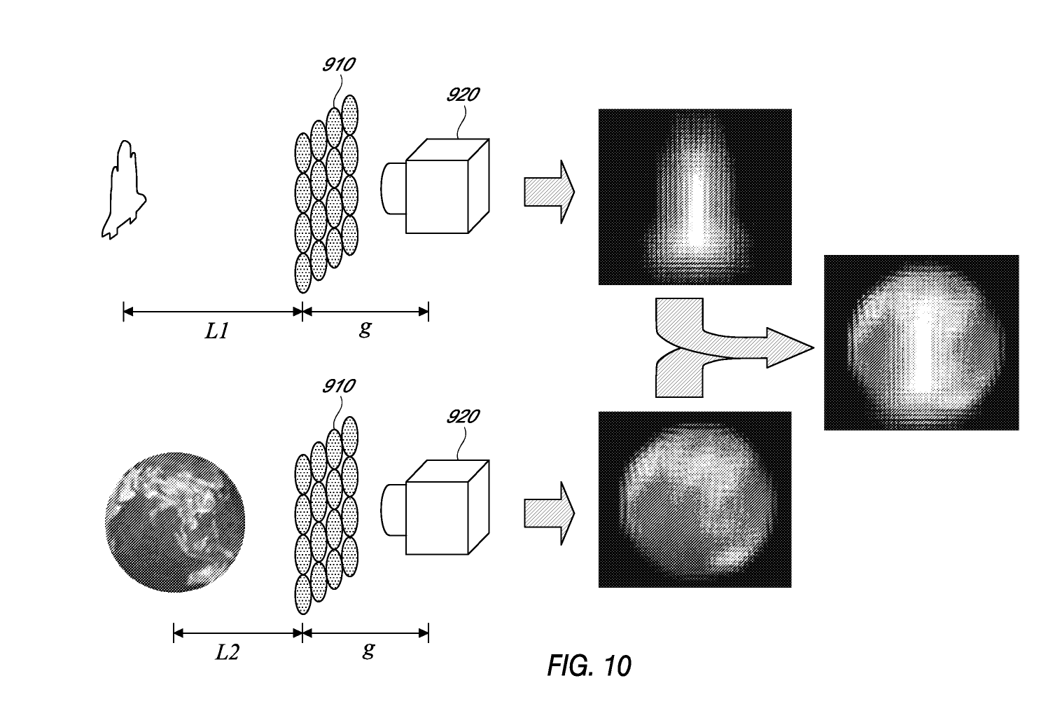

FIG. 9 shows how a device forming a composite image is configured according to an embodiment of the present invention, and FIG. 10 shows the process of forming a composite element image according to an embodiment of the present invention.

Referring to FIG. 9, a device for forming a composite image can include a lens unit 910, a sensor 920 and a composition unit 930.

The lens unit 910 is made by arranging a plurality of lenses or lenslets that pick up an element image of an object. The lens unit 910 can converge the light through the lenses or lenslets and output the light to the sensor 920.

The sensor 920 can sense the light converged by the lens unit 910 and form an element image corresponding to each lens or each lens let of the lens unit 910, and then can output the element image to the composition unit 930. The sensor 920 can separately form a mask image and a background image. The mask image is an integral image, which is constituted by an element image for a main object, displayed in the form of a binary image. The mask image functions as a mask for the background image. The background image corresponds to an integral image constituted by an element image for the background excluding the main object. The composition unit 930 can combine the background image and the mask image received from the sensor 920. For example, the composition unit 930 can perform a masking operation for the background image with the mask image. That is, the composition unit 930 can change a pixel of the background image that is correspondingly positioned to the white pixel of the mask image into a white pixel. A composite image, in which the background image and the mask image are combined in accordance with an embodiment of the present invention, is illustrated in FIG. 10. The composition unit 930 then outputs the composite image to an external device.

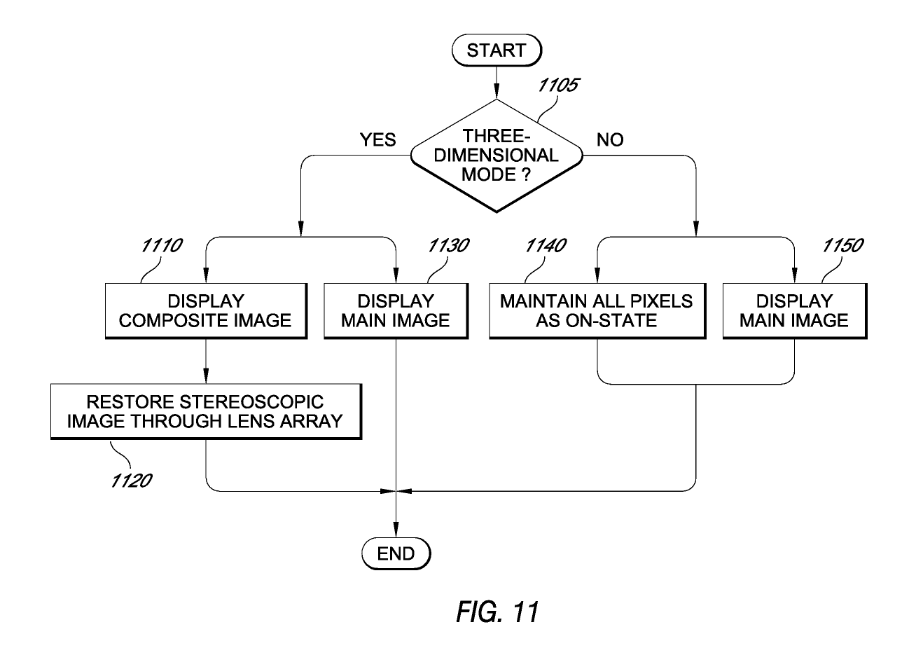

Hereinafter, a stereoscopic image display method using an integral image according to an embodiment of the present invention will be described with reference to FIG. 11.

FIG. 11 is a flowchart illustrating a process of displaying a stereoscopic image using an integral image according to an embodiment of the present invention.

In referring to FIG. 11 hereinafter, the function units shown in FIG. 4 will be used to describe the process, for the convenience of description and understanding of embodiments of the present invention.

Referring to FIG. 11, in step 1105, the control unit 410 determines whether the output mode of an input image is a three-dimensional output mode, by referring to at least one of a header file of the input image and a user setting and/or a default setting.

If the input image is in a three-dimensional mode, the first display unit 420 outputs the composite image in the form that a user can visually recognize, in step 1110.

In step 1120, the lens unit 440 restores the displayed composite image through a lens array. The restored image can be formed on the real image plane or the virtual image plane. If the restored image is formed on the virtual image plane, the three-dimensional effect of the overall three-dimensional image can be improved.

In step 1130, the second display unit 430 outputs the main image in the form that a user can visually recognize. If the input image is not in a three-dimensional mode, the first display unit 420 functions as a backlight by turning “on” all of the pixels, in step 1140. In step 1150, the second display unit 430 outputs the main image in the form that a user can visually recognize.

A method of forming the composite image, which is restored by the first display unit 420 and the lens unit 440 and is used as a background, will be described below.

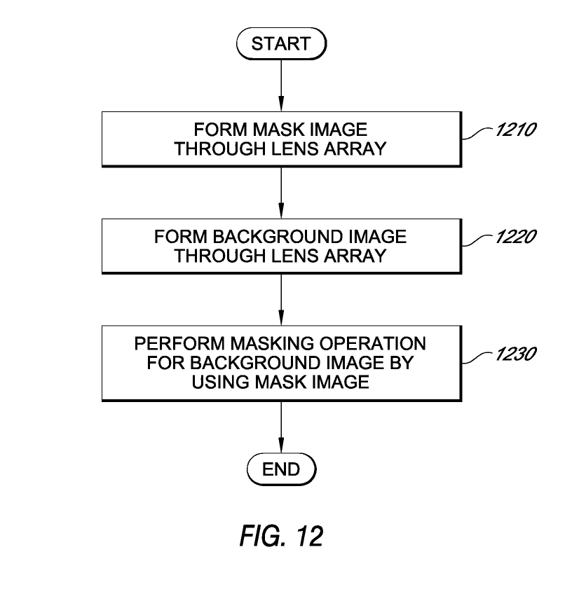

FIG. 12 is a flowchart illustrating a process of forming a composite image according to an embodiment of the present invention.

Referring to FIG. 12 and the function units shown in FIG. 9, the sensor 920 forms a mask image through the lens array (or the lenslet array) of the lens unit 910, in step 1210. The mask image, which is a kind of a binary image, functions as a mask of a background image. In step 1220, the sensor 920 forms a background image through the lens array (or the lenslet array) of the lens unit 910.

In step 1230, the composition unit 930 forms a composite image through a masking operation for the background image through use of the mask image. In effect, the composite image corresponds to an image formed by changing the color of an area of the background image that corresponds to the object area of the mask image into white. The pixels changed into white functions later as the backlight of the main image.

While the process is described to be sequentially performed between steps 1210 and 1220, it shall be evident that it is also possible to perform the process in parallel, depending on how the process is implemented.

While certain embodiments of the present invention have been described, it shall be understood by those skilled in the art that various changes and modification in forms and details may be made without departing from the spirit and scope of the present invention as defined by the appended claims.

What is claimed is:

1. A display device comprising:
a first display unit configured to selectively output one of a composite image and backlight, wherein the composite image comprises a background image and a mask image, for an object, wherein the background image comprises element images for a background excluding the object, and wherein the mask image is a white image which has the same shape as that of the object; a lens unit configured to convert the composite image into a stereoscopic image or pass through the backlight; and
a second display unit configured to output i) a two-dimensional (2D) image of the object by the use of the backlight at a 2D mode and ii) the combination of the 2D image and the composite image at a three dimensional (3D) mode.

2. The display device of claim 1, further comprising a control unit configured to control the first display unit to selectively output the composite image or backlight based on one of the 2D and 3D modes.

3. The display device of claim 1, wherein the second display unit is a transmissive spatial light modulator (SLM).

4. The display device of claim 1, wherein the lens unit comprises one of a lens array and a lenslet array (micro lens array).

5. A display method comprising:
selectively outputting one of a composite image and backlight, wherein the composite image comprises a background image and a mask image, for an object, wherein the background image comprises element images for a background excluding the object, and wherein the mask image is a white image which has the same shape as that of the object;
converting the composite image into a stereoscopic image or passing through the backlight;
outputting a two-dimensional (2D) image of the object by the use of the backlight at a 2D mode; and
outputting the combination of the 2D image and the composite image at a three dimensional (3D) mode.

6. The display method of claim 5, wherein the converting is performed by one of a lens array and a lenslet array (micro lens array).

7. The display method of claim 5, wherein the outputting of the 2D image and the combination image is performed by a transmissive spatial light modulator (SLM).

8. A display device comprising:
means for selectively outputting one of a composite image and backlight, wherein the composite image comprises a background image and a mask image, for an object, wherein the background image comprises element images for a background excluding the object, and wherein the mask image is a white image which has the same shape as that of the object;
means for converting the composite image into a stereoscopic image or passing through the backlight;
means for means for outputting a two-dimensional (2D) image of the object by the use of the backlight at a 2D mode; and
means for outputting the combination of the 2D image and the composite image at a three dimensional (3D) mode.
